(19) United States
(12) Patent Application Publication
(10) Pub. No.: US 2011/0067986 A1
(43) Pub. Date: Mar. 24, 2011

(54) VACUUM CIRCUIT BREAKER

(75) Inventors: Karsten Fleck, Oberkraemer Ortsteil Marwitz (DE); Juergen Jaeger, Berlin (DE); Guenter Seidler, Berlin (DE)

(73) Assignee: SIEMENS AKTIENGESELLSCHAFT, Muenchen (DE)

(21) Appl. No.: 12/918,884

(22) PCT Filed: Feb. 12, 2009
(86) PCT No.: PCT/EP2009/051629

§ 371 Date: Oct. 14, 2010

(30) Foreign Application Priority Data
Feb. 22, 2008 (DE) 10 2008 011 043.4

(51) Int. Cl. H01H 9/00

(52) U.S. Cl. 200/237

(57) ABSTRACT

In a vacuum circuit breaker for switching electric currents in the high-power range, a current conductor support is attached to the current conductor clamp for absorbing the high electro-dynamic attraction forces between the two current conductors subject to short-circuit current that run next to one another at a distance and to maintain the predetermined curvature of the current conductors so that the shut-off process or the shifting of the moving contact to the final position is not hindered.

The invention relates to a vacuum circuit breaker for switching electrical currents in the high power range, which vacuum circuit breaker comprises a fixed contact which is connected to an upper pole head, and a moving contact which is connected to a lower pole head by means of a current conductor clamp and flexible current conductors which run in the longitudinal direction at a distance from one another and which are curved outwards in opposite directions, and which is attached to a drive mechanism, and a vacuum switch tube which accommodates the two contacts.

Vacuum circuit breakers are known which are used for switching high currents in the medium-voltage range, in which vacuum circuit breakers the fixed contact connected to an upper pole head and the moving contact attached to a drive mechanism are located in the vacuum, and the connection between the moving contact and the lower pole head (pole carrier) is made by means of flexible current conductors which are arranged to run at a distance from one another. The two current conductors are curved outwards in opposite directions, thus guaranteeing their flexibility when the moving contact is displaced. However, the use of the above-mentioned known vacuum circuit breakers is restricted to a certain level of operating current and short-circuit current. In the case of switching operations in the highest power range with very high switch-on currents and short-circuit currents, trouble-free operation of the vacuum circuit breaker with the moving contact and the pole head which is connected thereto by means of the adjacent compact current conductors is not guaranteed, as with very high short-circuit currents and with corresponding switch-on currents, such large electrodynamic attraction forces prevail between the two current conductors that the displacement of the moving contact into a defined end position in the switched-off state cannot be achieved because of the deformation caused by the attraction forces.

The invention is therefore based on the object of further developing a vacuum circuit breaker of the type mentioned in the introduction so that its reliable switching operation is also guaranteed in the highest power range with high short-circuit and switch-on currents.

According to the invention, the object is achieved with a vacuum circuit breaker designed in accordance with the features of patent claim 1. Expedient and advantageous embodiments of the invention are the subject matter of the dependent claims.

In a vacuum circuit breaker of the kind described which is used for switching electrical currents in the highest power range, the basic concept of the invention consists in arranging a current conductor support on the current conductor clamp which is connected to the moving contact carrier in order to absorb the electrodynamic attraction forces between the two current conductors caused by very high short-circuit currents and to prevent a deformation of the current conductors which blocks the switch-off process. The arrangement of the current conductor support also enables electrical currents in the highest power range to be switched with vacuum circuit breakers.

The current conductor support, which in order to prevent a high temperature development is made of a non-magnetic material, is made in one piece and comprises a base plate which is mounted on the front surface of the current conductor clamp which faces the pole head connected to the current conductors, and the shape of which base plate corresponds to the cross section of the current conductor clamp, and from the two opposite side edges of which base plate current conductor supporting flanks project. The course of the current conductor supporting flanks essentially follows the normal curvature of the current conductors, which therefore maintain their predetermined curvature even at high short-circuit currents and cannot block the switch-off process or the displacement of the moving contact into the end position due to a deformation.

The one-piece design of the current conductor support and a stiffening web which connects the conductor supporting flanks on the side facing away from the slot opening of the base plate or the current conductor clamp ensure adequate stiffness. In order for the base plate to be able to follow the movement of the current conductor clamp even better when it is fixed to the moving contact carrier, the base plate has a notch, namely in the part of the base plate which lies opposite its open side.

In an embodiment of the invention, the current conductor supporting flanks comprise a first vertical flank section which is attached to the base plate, a flank section which is attached thereto and is angled downwards and outwards, and a second vertical flank section attached thereto. The stiffening web preferably connects the two first vertical flank sections of the current conductor supporting flanks.

An exemplary embodiment of the invention is explained in more detail with reference to the drawing. In the drawing:

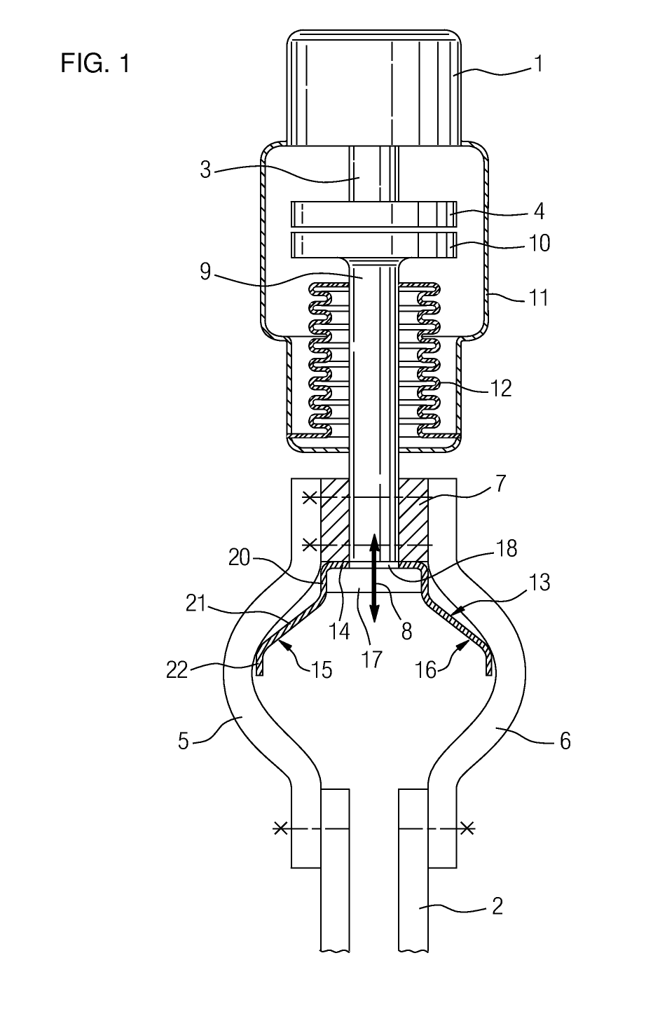

FIG. 1 Shows a part view of the current path of a vacuum circuit breaker; and

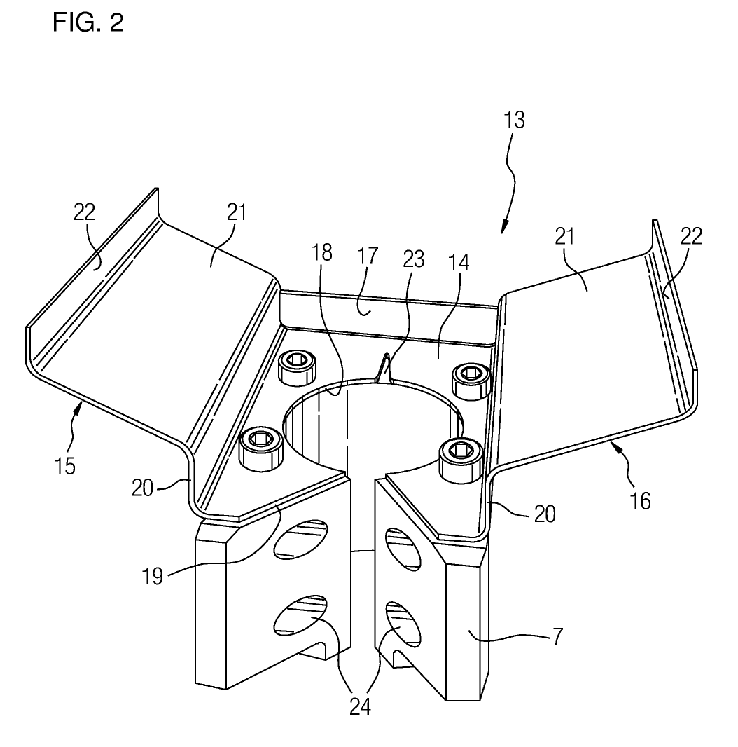

FIG. 2 shows a perspective view of the current conductor clamp with a current conductor support fixed thereto.

An upper pole head 1 and a lower pole head 2, which in each case are connected to connecting bars (not shown), are shown in FIG. 1. An upper contact carrier 3 with fixed contact 4 is rigidly fixed to the upper pole head 1. Two opposing current conductors 5 and 6 a distance apart are fitted to the lower pole head 2 by their respective bottom ends and are fixed to a current conductor clamp 7 by their upper ends. The current conductor clamp 7 is clamped to a contact carrier 9, which can be displaced by a drive mechanism according to arrow 8, and to the free end of which a moving contact 10 is fitted. The two contacts 4 and 10 are located in a vacuum switch tube 11. A bellows 12 is fixed to the moving contact carrier 9, the bottom end of which is connected to the bottom of the vacuum switch tube 11 in order thus to create a vacuum-tight connection between the moving contact carrier 9 and the body of the vacuum switch tube 11.

A current conductor support 13, which is made of a non-magnetic material, is fixed to the underside of the current conductor clamp 7, which is elastically clamped to the moving contact carrier 9 by means of bolts (not shown), which are guided in through holes 24. By making the current conductor support from a non-magnetic material, excessive self-heating is prevented. The current conductor support 13 consists of a base plate 14 which can be screwed to the face of the current conductor clamp 7 and has two current conductor supporting flanks 15, 16 which project outwards from the sides. Starting from the base plate 14, the two current conductor supporting flanks 15, 16 initially run in a first essentially vertical flank section 20, then in a flank section 21 which is angled outwards and downwards, and then once more in a second essentially vertical flank section 22, the transitions between the flank sections being rounded. The base plate 14 is designed to correspond to the shape of the front surface of the current conductor clamp 7 which can be elastically clamped to the moving contact carrier 9, and therefore has a centric opening 18 from which extends a slot opening 19, the width of which increases towards the outside. A stiffening web 17 is fitted on the side opposite the slot opening 19 which connects the two current conductor supporting flanks 15, 16 on this side in the area of the first vertical flank section 20 in order to provide mutual stiffening and to absorb the high forces caused by short-circuit currents. A short notch 23 is formed in the base plate 14 on the side opposite the slot opening 19. The shape of the base plate 14 described above enables the one-piece current conductor support 13 to follow the elastic movement of the current conductor clamp 7 when clamped to the moving contact carrier 9. On the other hand however, a high stiffness of the current conductor support 13 is guaranteed as a result of the one-piece design and the single-sided arrangement of the stiffening web 17. The high forces acting on the current conductors 5, 6 in vacuum circuit breakers with high switch-on and short-circuit currents are absorbed by the current conductor support 13 so that the current conductors maintain their predetermined curvature and the displacement of the contact carrier 9 carrying the moving contact 10 is not hindered during the switch-off process and the reliable operation of a vacuum circuit breaker working in the highest power range is guaranteed in spite of the very high electromagnetic attraction forces acting between the current conductors.

1-7. (canceled)

8. A vacuum circuit breaker for switching electrical currents in a high power range, the vacuum circuit breaker comprising:
a fixed contact connected to an upper pole head;
a moving contact movably disposed relative to said fixed contact;
a current conductor clamp and flexible current conductors connecting said moving contact to a lower pole head;
said flexible current conductors running in a longitudinal direction at a spacing distance from one another and being outwardly curved in opposite directions;
a current conductor support fitted on said current conductor clamp and configured to absorb electrodynamic attraction forces between said current conductors caused by short-circuit currents and to support said current conductors according to a predetermined curvature thereof;
a drive mechanism connected to said moving contact;
a vacuum switch tube accommodating said fixed contact and said moving contact.

9. The vacuum circuit breaker according to claim 8, wherein said current conductor support is made in one piece and comprises a base plate mounted on a front face of said the current conductor clamp facing said lower pole head and having two current conductor supporting flanks projecting laterally outwards therefrom and having a shape substantially corresponding to the predetermined curvature of said current conductors.

10. The vacuum circuit breaker according to claim 9, wherein said base plate corresponds with a cross section of said current conductor clamp and said base plate is formed with a central opening and a slot opening extending therefrom and having a width increases towards an edge.

11. The vacuum circuit breaker according to claim 10, wherein a notch is formed in said base plate on a side opposite said slot opening.

12. The vacuum circuit breaker according to claim 9, which comprises a stiffening web connecting said current conductor supporting flanks on a side opposite said slot opening.

13. The vacuum circuit breaker according to claim 9, wherein said current conductor supporting flanks comprise a first, substantially vertical flank section, a flank section that is angled downwardly and outwardly, and a second, substantially vertical flank section.

14. The vacuum circuit breaker according to claim 8, wherein said current conductor support is formed of a non-magnetic material.
